(19) United States
(12) Patent Application Publication
(10) Pub. No.: US 2025/0250795 A1
(43) Pub. Date: Aug. 7, 2025

(54) SNAP-FIT FABRIC BUILDING MODULE

(71) Applicant: Guanghui HE, Shanghai (CN)

(72) Inventor: Guanghui HE, Shanghai (CN)

(21) Appl. No.: 19/184,706

(22) Filed: Apr. 21, 2025

Related U.S. Application Data
(63) Continuation of application No. PCT/CN2024/094145, filed on May 20, 2024.

(30) Foreign Application Priority Data
Jul. 3, 2023 (CN) 202310798017.5

(51) Int. Cl. E04C 2/38; E04C 2/00; E04C 2/52; F21V 19/00; G09F 13/04

(52) U.S. Cl. CPC E04C 2/384; E04C 2/526; F21V 19/004; G09F 13/0446; E04C 2002/001

(57) ABSTRACT

This invention provides a snap-fit building module, which includes frame, lining board and light board. The frame comprises upper profile, lower profile, left profile, right profile, and four corner connectors. Two decorative planes are formed on either side of frame. The upper, lower, left, and right profiles and the four corner connectors are connected via mounting holes 1. The lining board and light board can be selectively installed within frame without protruding beyond decorative planes. The lining board and light board are connected to frame through mounting holes 1 and 2. Advantages of the utility model include: recyclability; environmental friendliness; quick and easy disassembly/assembly; accurate installation positioning with minimal error; a flush appearance of the booth walls, and the ability to install the lining board and light board within frame without protruding beyond decorative planes, thereby minimizing risk of damage to lining board and light board due to impact.

### CROSS-REFERENCE TO RELATED APPLICATIONS

This application is a continuation of co-pending International Patent Application No. PCT/CN2024/094145, filed on May 20, 2024, which claims the priority and benefit of Chinese patent application number 202310798017.5, filed on Jul. 3, 2023 with China National Intellectual Property Administration, the entire contents of which are incorporated herein by reference.

### TECHNICAL FIELD

The present invention pertains to the field of exhibition displays, performances, and advertising structure construction, particularly concerning a snap-fit fabric building module.

### BACKGROUND

The existing components of exhibition booths, stages, and advertising platforms have the following drawbacks: 1) The materials used for frames of the building modules are all wood, which can only be used once and cannot be recycled, resulting in a waste of forest resources and poor environmental friendliness; 2) The connection between module frames is achieved through welding, bonding, or bolt connection, which not only requires a long time for disassembly and assembly, but also wastes a significant amount of manpower, material resources, and financial resources; 3) There are considerable installation errors in the above-mentioned connection methods between module frames, which can eventually lead to the failure to achieve the construction goal due to the accumulation of significant errors; 4) To form a complete building system, existing technologies require the assembly of multiple frames with connectors before installing the external decorative panels on the frames, and disassembly involves removing the external decorative panels before disassembling the connected frames, thus causing time-consuming disassembly and assembly and low building efficiency.

Therefore, there is currently a need for a building module component that can be recycled repeatedly, is environmentally friendly, can be assembled and disassembled quickly and easily, and offers has accurate positioning and minimal error in the connection between modular components.

Addressing these issues, a Chinese patent [CN108756333A] discloses a building module component comprising a module frame made of profiles, with one pair of opposite profiles equipped with positioning pins and positioning pin lock pieces, and another pair of opposite profiles equipped with positioning pins and positioning bolt holders. Additionally, the patent describes a facial decoration part mounted on the frame module. However, since the facial decoration part protrudes from the frame module, it is prone to damage from impacts during installation or operation, necessitating the development of a novel type of building module.

### SUMMARY

To address the technical issue in existing technologies where the facial decoration part of the frame module is prone to damage due to impacts, the present invention is implemented as follows:
A snap-fit fabric building module comprising a frame, a lining board, and a light board;
Said frame includes an upper profile, a lower profile, a left profile, a right profile, and four corner connectors, with two decorative planes formed on either side of the frame;
Said upper profile, lower profile, left profile, right profile, and the four corner connectors are connected through mounting holes 1;
Said lining board and the light board can be selectively installed within the frame;
Said lining board and light board can be installed inside the frame without protruding beyond the decorative plane;
Said lining board and light board are connected to the frame through mounting hole 1 and mounting hole 2.

Preferably, said upper profile, said lower profile, said left profile, and said right profile are four profiles with identical cross-sections;
At least one of said upper profile, said lower profile, said left profile, and said right profile is provided with at least one of the following: positioning pin, positioning pin lock piece, positioning bolt, and positioning bolt holder;
Said positioning pin includes a head portion, a rod portion, and a mounting rod;
Said positioning pin lock piece is provided with interconnected holes 1 and 2. The size of hole 1 allows the head to pass through, while the size of hole 2 does not allow the head to pass through but allows the rod to pass through.

Said positioning bolt includes a bot head and a bolt rod, with said bolt head connected to said bolt rod. Said positioning bolt holder is provided with a slot or hole for the insertion of said positioning bolt.

Preferably, said positioning pin is disposed on said upper profile; said positioning pin lock piece is disposed on said lower profile; said positioning bolt is disposed on said right profile; and said positioning bolt holder is disposed on said left profile.

Preferably, a snap-fit building module is disclosed, characterized in that said upper profile, said lower profile, said left profile, and said right profile have cavities, groove 1, and groove 2 that extend in the longitudinal length direction of the profile;
Said groove 1 and said groove 2 are disposed on one side of said upper profile, said lower profile, said left profile, and said right profile;
Said groove 1 is provided with a through hole 1 for said positioning pin to pass through, a through hole 2 for said positioning pin lock piece to insert into, and a through hole 3 for installing said positioning bolt and said positioning bolt holder;
Said through hole is surrounded by a mounting hole 3;
Both said positioning bolt and positioning bolt holder is disposed on the bottom of said groove 1;
Said four corner connectors are inserted into said cavities of adjacent two profiles;
Said cavities of said upper profile and said lower profile are inserted with support piece 1 within frame and support piece 2 within frame, while said cavities of said left profile and said right profile are inserted with support piece 1 within frame and support piece 3 within frame;
Said corner connectors and said support piece 1 within frame are both provided with an insertion hole 1 for said positioning pin to pass through and insertion hole 2 for the positioning pin lock piece to pass through;
Said support piece 2 within frame is used to install said positioning bolt and said positioning bolt holder on said left profile and said right profile;
Said support piece 3 within frame is provided with insertion hole 3;
The orientation of said support piece 3 within frame is the same or opposite to that of support piece 1 within frame.

Preferably, said frame further includes a transverse support module;
Said transverse support module includes a transverse support piece and a transverse support frame;
Said transverse support frame is provided with at least one reinforcing rib;
When there are two said reinforcing ribs, said transverse support piece is inserted at both ends of said support piece and connected by bolts;
Said transverse support frame is provided with a mounting hole 2, and said lining board and said light board can be connected to said transverse support frame through said installation hole 2;
Said transverse support frame is aligned with said left profile and said right profile and connected to said support piece 3 within frame.

Preferably, said head is a spherical head, and said rod is a cylindrical rod;
Said rod includes a small-diameter rod connected to a large-diameter rod; One end of said small-diameter rod is connected to said head portion, and the other end is connected to the large-diameter rod;
The diameter of said small-diameter rod is less than the diameter of said spherical head. One end of said large-diameter rod is connected to said small-diameter rod, and the other end is connected to said upper profile;
Said mounting rod is connected to said through hole 1;
Said positioning pin lock piece is a hollow tube with a circular cross-section. Said hole 1 is a circular hole, and said hole 2 is a slotted hole extending along the circumference of the cross-section of the hollow tube.

Preferably, at least one end of said positioning pin lock piece is provided with a claw portion for driving the rotation of the positioning pin lock piece;
Said positioning pin lock piece is provided with a head friction limiting member fixedly disposed therein. When the head portion is inserted into hole 1 and the hollow tube is rotated around its axis, the rod enter hole 2, and said head friction limiting member is in frictional contact with the head;
The width of said hole 2 allows the small-diameter rod to enter hole 2 but does not allow the small-diameter rod to move in the width direction of hole 2.

Preferably, said frame also includes positioning locks and positioning lock retainers;
Said positioning lock is disposed on one of a pair of opposite profiles;
Said positioning lock includes a retractable and extendable lock bolt, a lock bolt-holding hollow tube, and a spring;
Said lock bolt comprises a bolt rod and a positioning lock bolt head;
Said bolt rod is mounted on said spring and installed within the cavity of said lock bolt-holding hollow tube;
One end of said lock bolt rod is connected to said positioning lock bolt head, and the other end is fixed with a pressure plate;
The inner wall of said lock bolt-holding hollow tube has a pressing portion for pressing said spring;
Said spring is compressed between said pressure plate and said pressing portion;
Said lock bolt rod is provided with a steering rod near said positioning lock bolt head;
Said lock bolt-holding hollow tube is provided with rod slot 1 and rod slot 2 extending in longitudinal direction of said lock bolt-holding hollow tube near the end with said positioning lock bolt head;
The depth of said rod slot 1 is greater than the depth of said rod slot 2;
When said positioning lock bolt head abuts against the end of said lock bolt-receiving hollow tube, said steering rod is located within said rod slot 1; when said positioning lock bolt head is inserted into said through hole 2, said steering rod is located within said rod slot 2;
Said positioning lock retainer is provided with a through cavity;
Said positioning lock bolt head is nested within said through cavity;
Said through cavity is nested within said through hole 2;
A bolt passes through mounting hole 3 to fix the positioning lock retainer to the profile.

Preferably, said bolt head is a disc-shaped head; said bolt rod includes a cylindrical connecting bolt rod and a fixed bolt rod;
One end of said connecting bolt rod is connected to said disc-shaped bolt head, and the other end of said connecting bolt rod is connected to said fixed bolt rod;
Said positioning bolt also includes a positioning mounting plate; said positioning mounting plate is provided with a plurality of insertion holes 1;
Said fixed bolt rod passes through one of insertion holes 1 and one of said mounting holes 2 in sequence, and is connected to said support piece 2 within frame; the bolt passes through the remaining said insertion holes 1 and said mounting holes 2 in sequence, and is connected to Second support piece 2;
Said positioning bolt holder includes insertion hole 2 for said bolt head to insert into and insertion hole 3 for said bolt rod to insert into;
The size of said insertion hole 3 does not allow said bolt head to pass through;
Said positioning bolt holder is a hollow tube, and said insertion hole 2 is the cavity of said hollow tube;
Said insertion hole 3 is a slot-shaped hole in the wall of said hollow tube that extends longitudinally along said hollow tube;
One end of said insertion hole 3 extends to the end of the hollow tube; An insertion hole 4 is provided on said positioning bolt holder;
A bolt passes through mounting hole 2 on said left profile and said insertion hole 4 in sequence, and is connected to said support piece 2.

Preferably, at least one side of the front and back sides of the frame is provided with a fabric surface; said fabric surface covers said decorative plane and snap-fitted in said groove 1.

Implementation of this invention addresses the technical issue in existing technologies where the facial decoration part is prone to damage due to impacts. The invention achieves this by setting a lining board or light board within the frame, which does not protrude beyond the decorative surface, thereby reducing the likelihood of damage from impacts to the decorative surface composed of the light board and the lining board.

The beneficial effects of this invention:
1) The frame, positioning pins, positioning pin locks, positioning bolts, positioning bolt holders, and positioning locks of the building module components of this invention are preferably made of metal, while the facial decoration part is made of plastic. All components are recyclable and reusable, thereby avoiding waste of forest resources and exhibiting excellent environmental friendliness.
2) The connection of the upper and lower building module components requires only the insertion of a positioning pin from one module into the positioning pin lock piece of another module, causing the lock to move, preferably rotating. The connection of the left and right building module components needs only one step: inserting a positioning bolt from one module into the positioning bolt holder of another. Alternatively, adding a positioning lock into a lock hole can form two installation steps. Compared to traditional bolted or welded connections, the connection and disassembly of these module components are exceptionally convenient and swift, significantly reducing labor, material, and financial costs.
3) All building module components of this invention are standardized to significantly reduce the customization cycle and economic costs.
4) The upper and lower, as well as left and right building module components, can all be accurately positioned during installation to remarkably reduce errors during the installation & connection.
5) When two building module components are assembled together, the positioning pins, positioning bolts, positioning bolt holders, and positioning locks are all concealed within the frame members of the building module, resulting in a visually appealing overall design.
6) The light board and lining board are installed within the decorative plane formed by the frame module to effectively reduce damage from impacts. Where the snap-fit fabric building module of this invention is reused, only the snap-fit fabric installed in groove 2 needs to be replaced, thus ensuring ease of use.

### BRIEF DESCRIPTION OF DRAWINGS

To give a clearer description of the technical solutions in the embodiments of the present invention or the prior arts, the drawings needed for the description of the embodiments or prior arts are briefly presented below. Obviously, the drawings described below deal only with an embodiment of present invention. Ordinary skill in the art can obtain other drawings based on the said drawings without making creative efforts.

FIG. 1 is an exploded perspective view of a snap-fit fabric building module according to an embodiment of the present invention;

FIG. 2 is an overall structural diagram of an embodiment of the present invention;

FIG. 3 is a structural diagram showing installation of the lining board and the snap-fit fabric in an embodiment of the present invention;

FIG. 4 is a cross-sectional view of installation of the lining board and the snap-fit fabric in an embodiment of the present invention;

FIG. 5 is a structural diagram showing installation of the light board in an embodiment of the present invention;

FIG. 6 is a structural diagram of the positioning pin;

FIG. 7 is a perspective view of the positioning pin lock piece using a hollow circular tube in an embodiment of the present invention;

FIG. 8 is a structural diagram of the connection between the positioning pin lock piece and the support piece 2 within frame;

FIG. 9 is a structural diagram of the limit ring;

FIG. 10 is a structural diagram of the head friction limiting member;

FIG. 11 is a structural diagram of the positioning bolt;

FIG. 12 is a left view of a snap-fit fabric building module according to an embodiment of the present invention;

FIG. 13 is a structural diagram of the transverse support piece in an embodiment of the present invention;

FIG. 14 is a structural diagram of the connection between the transverse support piece and the lining board in an embodiment of the present invention;

FIG. 15 is an exploded perspective view of the positioning lock in an embodiment of the present invention;

FIG. 16 is a perspective view of the positioning lock with bolt in a retracted state in an embodiment of the present invention;

FIG. 17 is a perspective view of the positioning lock with bolt in an extended state in an embodiment of the present invention;

FIG. 18 is a perspective view of the positioning mounting plate in an embodiment of the present invention;

FIG. 19 is a structural diagram of the positioning bolt holder;

FIG. 20 is a structural diagram of combination of the positioning bolt holder, positioning bolt, and positioning mounting plate;

FIG. 21 is a cross-sectional view of two building modules connected to each other;

FIG. 22 is a structural diagram in an embodiment of the present invention, showing two building modules being connected where the positioning pin is inserted into hole 1 of hollow circular tube without rotation;

FIG. 23 is a structural diagram of a snap-fit fabric building module with installed lining board and light board being connected;

FIG. 24 illustrates the process of installing snap-fit fabric building modules.

In the aforementioned drawings, the reference numerals denote the following components:
1. Upper Profile
1-1—Positioning Pin
1-1-1—Head
1-1-2—Rod
1-1-2-1—Small-Diameter Rod
1-1-2-2—Large-Diameter Rod
1-1-3—Mounting Rod
2. Lower Profile
2-1—Positioning Pin Lock Piece
2-1-1—Hole 1
2-1-2—Hole 2
2-1-3—Claw Portion
2-1-4—Head Friction Limiting Member
2-1-5—Limit Ring
2-1-6—Limit Slot
2-1-7—Limiting Bolt 1
2-2—Support Piece 1 within Frame
2-2-1—Limiting Bolt 2
2-2-2—Limiting Bolt 3
2-3—Support Piece 2 within Frame
3. Left Profile
3-1—Groove 1
3-1-1—Installation Hole 1
3-1-2—Installation Hole 2
3-1-3—Installation Hole 3
3-1-4—Through Hole 1
3-1-5—Through Hole 2
3-1-6—Through Hole 3
3-2—Groove 2
3-3—Cavity
3-4—Positioning Bolt Holder
3-4-1—Insertion Hole 2
3-4-2—Insertion Hole 3
3-4-3—Insertion Hole 4
3-5—Support Piece 3 within Frame
3-5-1—Insertion Hole 3
4. Right Profile
4-1—Positioning Bolt
4-1-1—Bolt Head
4-1-2—Bolt Rod
4-1-3—Positioning Mounting Plate
4-1-3-1—Insertion Hole 1
5. Corner Connector
5-1—Insertion Hole 1
5-2—Insertion Hole 2
6. Decorative Plane
7. Lining Board
8. Light Board
9. Transverse Support Module
9-1—Transverse Support Piece
9-2—Transverse Support Frame
9-2-1—Reinforcing Rib
10—Positioning Lock
10-1—Lock Bolt
10-1-1—Lock Bolt Rod
10-1-2—Positioning Lock Bolt Head
10-1-3—Pressure Plate
10-1-4—Steering Rod
10-2—Lock Bolt-receiving Hollow Tube
10-2-1—Rod Slot 1
10-2-2—Rod Slot 2
10-3—Spring
11—Positioning Lock Retainer
11-1—Through Cavity.

### DESCRIPTION OF EMBODIMENTS

The drawings in embodiments of the present invention are used to give a clearer and more complete description of the technical solutions in embodiments of the present invention. It is obvious that the described embodiments are just part of the embodiments of the present invention. Based on embodiments of the present invention, every other embodiment achieved by the one of ordinary skill in the art without creative efforts is deemed within the protection scope of the present invention.

### EMBODIMENT

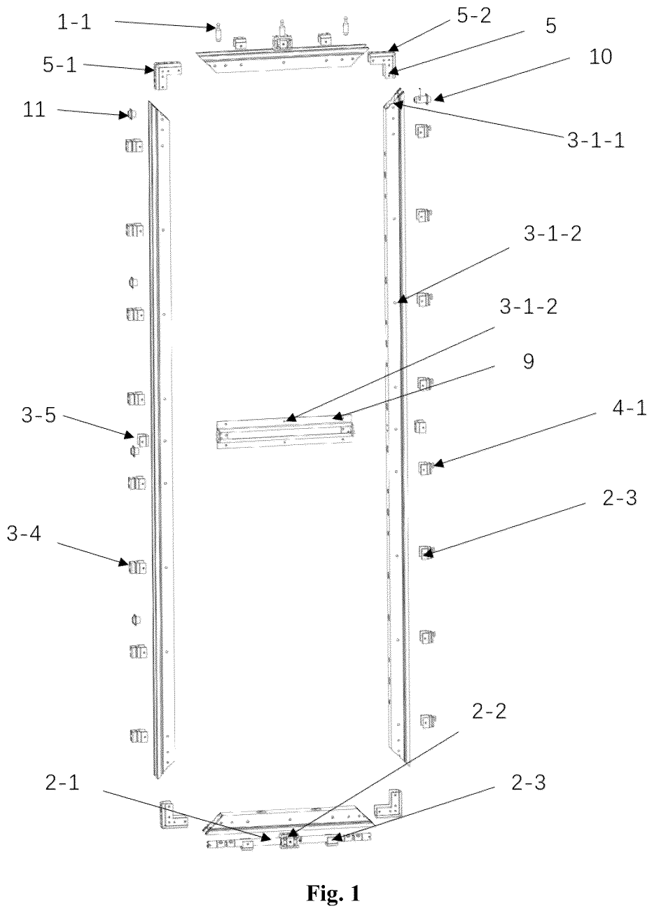

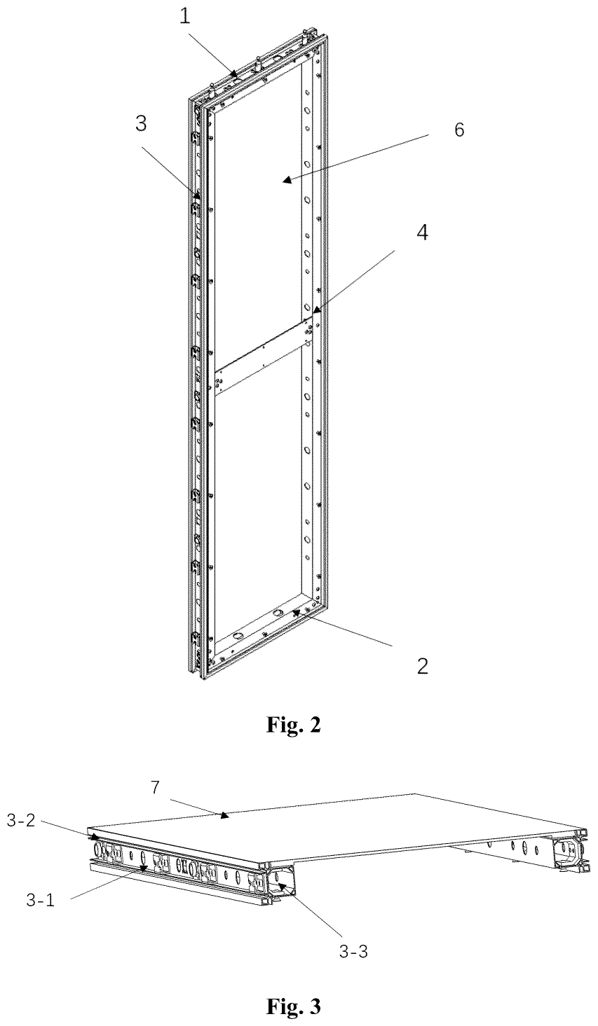

In a specific embodiment, as shown in FIGS. 1 and 2, a snap-fit fabric building module includes a frame, a lining board 7, and a light board 8; the frame comprises an upper profile 1, a lower profile 2, a left profile 3, a right profile 4, and four corner connectors 5, with two decorative planes 6 formed on either side of the frame; the upper profile 1, lower profile 2, left profile 3, right profile 4, and the four corner connectors 5 are connected via mounting hole 1 3-1-1. The lining board 7 and the light board 8 can be optionally installed within the frame. Here, the upper profile 1, lower profile 2, left profile 3, and right profile 4 are four profiles with identical cross-sections.

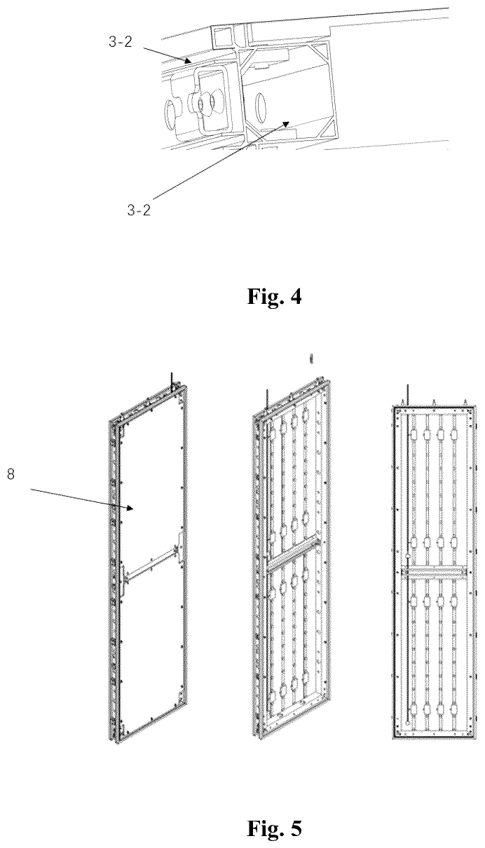

As shown in FIGS. 3, 4, and 5, the lining board 7 and the light board 8 can be installed inside the frame without protruding beyond the decorative plane 6. The lining board 7 and the light board 8 are connected to the frame through mounting hole 1 3-1-1 and mounting hole 2 3-1-2.

On one pair of opposing profiles among the upper profile 1, lower profile 2, left profile 3, and right profile 4, there are respectively provided a positioning pin 1-1 and a positioning pin lock piece 2-1.

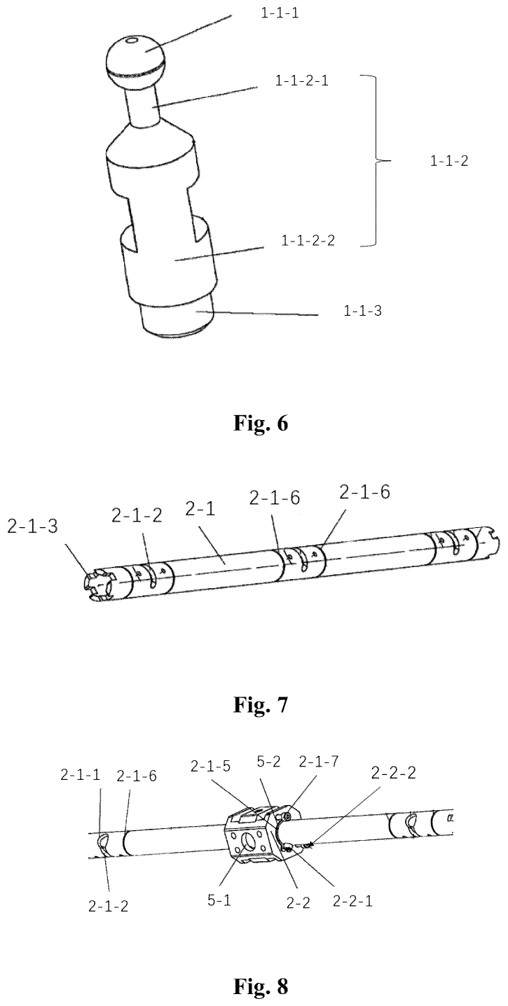

As shown in FIG. 6, the positioning pin 1-1 comprises a head 1-1-1, a rod 1-1-2, and a mounting rod 1-1-3; the head 1-1-1 is spherical, the rod 1-1-2 being cylindrical, and the rod 1-1-2 including a small-diameter rod 1-1-2-1 and a large-diameter rod 1-1-2-2 that are connected. One end of the small-diameter rod 1-1-2-1 is connected to the head 1-1-1, and the other end is connected to the large-diameter rod 1-1-2-2. The diameter of the small-diameter rod 1-1-2-1 is smaller than that of the spherical head. One end of the large-diameter rod 1-1-2-2 is connected to the small-diameter rod 1-1-2-1, and the other end is connected to the upper profile 1. To facilitate installation of the positioning pin 1-1, a groove is provided on the large-diameter rod 1-1-2-2 for tool gripping. In this embodiment, the positioning pin is installed on the upper profile 1 through connection of the mounting rod 1-1-3 and through hole 1 3-1-4.

As depicted in FIGS. 7 and 8, the positioning pin lock piece 2-1 features hole 1 2-1-1 and hole 2 2-1-2 that communicate with each other. The diameter of hole 1 2-1-1 is sufficient to allow the passage of the head 1-1-1, whereas the diameter of the hole 2 2-1-2 is too small for the head 1-1-1 to pass through but large enough for the rod 1-1-2. The positioning pin lock piece 2-1 is a hollow tube with a circular cross-section, the hole 1 2-1-1 being a circular hole, and hole 2 2-1-2 being a slotted hole extending along the circumference of the tube's cross-sectional ring. Specifically, the width of hole 2 2-1-2 permits the entry of the small-diameter rod 1-1-2-1 but restricts its movement along the width of hole 2 2-1-2.

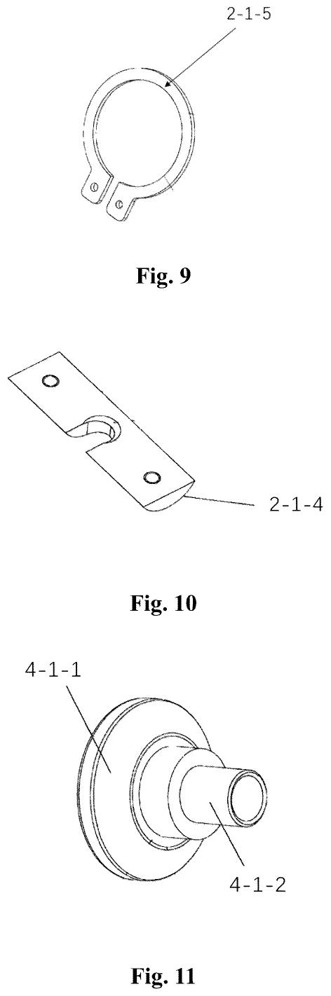

As illustrated in FIG. 9, the positioning pin lock piece 2-1 includes a limit ring 2-1-5, which is securely attached to support piece 1 within frame 2-2. On the external surface of the positioning pin lock piece 2-1, there is a limit slot 2-1-6 that extends circumferentially along the cross-section of the cylindrical hollow tube. The limit ring 2-1-5 is inserted into this slot, with its outer circumference extending beyond the limit slot 2-1-6 and resting against support piece 1 within frame 2-2. This arrangement prevents the cylindrical hollow tube from moving relative to support piece 1 within frame 2-2 and the frame corner connector 5 along its tube axis. Additionally, limiting bolt 1 2-1-7 is fixedly mounted on positioning pin lock piece 2-1, and limiting bolts 2 and 3 2-2-2 are fixedly mounted on the support piece 1 2-2 within frame. When the circular hollow tube rotates a certain angle around its axis in a clockwise direction, limiting bolt 1 2-1-7 abuts against limiting bolt 2 2-2-1 to prevent the circular hollow tube from continuing to rotate clockwise. When the circular hollow tube rotates a certain angle around its axis in a counterclockwise direction, the limiting bolt 1 2-1-7 abuts against the limiting bolt 3 2-2-2 to prevent the circular hollow tube from continuing to rotate counterclockwise. This ensures that the circular hollow tube rotates into place without excessive rotation.

At least one end of the positioning pin lock piece 2-1 has a claw portion 2-1-3 for driving the rotation of the positioning pin lock piece 2-1.

As shown in FIG. 10, positioning pin lock piece 2-1 is provided with a head friction limiting member 2-2-4 fixedly disposed therein. When the head portion 1-1-1 is inserted into hole 1 2-1-1 and the hollow tube is rotated around its axis, the rod 1-1-2 enters hole 2 2-1-2, and head friction limiting member 2-2-4 is in frictional contact with the head 1-1-1.

The other opposite profiles of the upper profile 1, lower profile 2, left profile 3, and right profile 4 are each provided with a positioning bolt 4-1 and a positioning bolt holder 3-4.

As shown in FIG. 11, the positioning bolt 4-1 includes a bolt head 4-1-1 and a bolt rod 4-1-2, where the bolt head 4-1-1 is connected to the bolt rod 4-1-2. The positioning bolt holder 3-4 is provided with a slot or hole for inserting the positioning bolt 4-1.

The positioning pin 1-1 is arranged on the upper profile 1; the positioning pin lock piece 2-1 is arranged on lower profile 2; the positioning bolt 4-1 is arranged on right profile 4, and the positioning bolt holder 3-4 is arranged on left profile 3. It should be noted that the definitions of upper profile 1, lower profile 2, left profile 3, and right profile 4 mentioned in this embodiment refer to the orientation in which the building module faces the user.

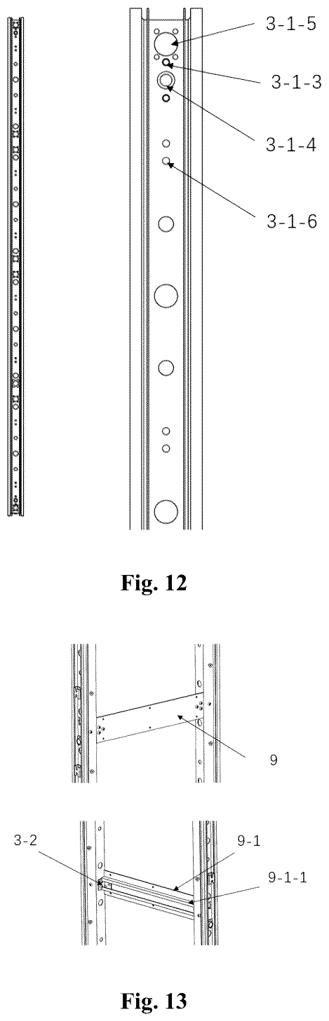

As shown in FIG. 12, the upper profile 1, lower profile 2, left profile 3, and right profile 4 have a cavity 3-3, groove 1 3-1, and groove 2 3-2 extending in the longitudinal length direction of the profile;
Groove 1 3-1 and groove 2 3-2 are arranged on one side of the upper profile 1, lower profile 2, left profile 3, and right profile 4. Groove 1 3-1 is provided with through hole 1 3-1-4 for the positioning pin 1-1 to pass through, through hole 2 3-1-5 for the positioning pin lock piece 2-1 to insert into, and through hole 3 3-1-6 for installing the positioning bolt 4-1 and the positioning bolt holder 3-4. Through hole 2 3-1-5 is surrounded by mounting hole 3 3-1-3.

The positioning bolt 4-1 and the positioning bolt holder 3-4 are both arranged on the bottom of the groove 1 3-1. Four corner connectors 5 are inserted into the cavities 3-3 of adjacent profiles.

The cavities 3-3 of the upper profile 1 and the lower profile 2 are also inserted with support piece 1 2-2 within frame and support piece 2 2-3 within frame. The support piece 2 2-3 is used to install the positioning bolt 4-1 and the positioning bolt holder 3-4 on the left profile 3 and the right profile 4, respectively.

The cavities 3-3 of the left profile 3 and the right profile 4 are also inserted with support piece 1 2-2 within frame and support piece 3 3-5 within frame. The support piece 3 3-5 within frame is provided with insertion hole 3, and in this embodiment, the setting direction of support piece 3 3-5 within frame is opposite to that of support piece 1 2-2 within frame.

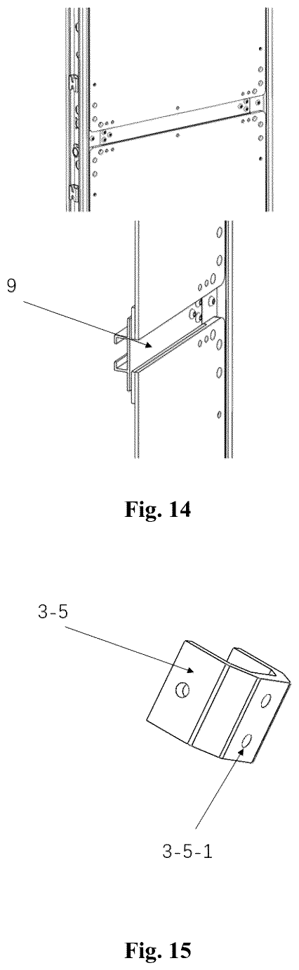

Both the corner connector 5 and the support piece 1 2-2 within frame is provided with insertion hole 1 5-1 for the positioning pin 1-1 to pass through and a insertion hole 2 5-2 for the positioning pin lock piece 2-1 to pass through;
As shown in FIGS. 13 and 14, a transverse support module 9 is also arranged within the frame, which includes a transverse support piece 9-1 and a transverse support frame 9-2. The transverse support frame 9-2 is arranged within two reinforcing ribs 9-2-1. The transverse support piece is inserted at both ends of the transverse support frame 9-2 and connected by a bolt. The transverse support frame 9-2 is provided with a mounting hole 2 3-1-2, through which the lining board 7 and the light board 8 are connected to the transverse support frame 9-2. As shown in FIG. 15, the transverse support frame 9-2 is in close contact with the left profile 3 and the right profile 4, and is connected to the support piece 3 3-5 within frame through insertion hole 3 3-5-1.

The frame also includes a positioning lock 10 and a positioning lock retainer 11, where the positioning lock 10 is arranged on one of a pair of opposite profiles.

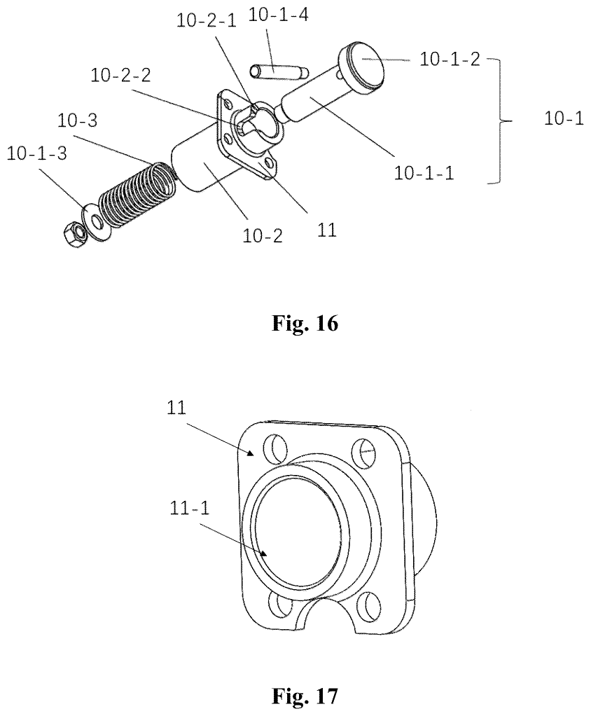

As shown in FIG. 16, the positioning lock 10 includes an extendable and retractable lock bolt 10-1, a lock bolt-receiving hollow tube 10-2, and a spring 10-3. The lock bolt 10-1 comprises a lock bolt rod 10-1-1 and a positioning lock bolt head 10-1-2. The lock bolt rod 10-1-1 is fitted over the spring 10-3 and installed within the tube cavity of lock bolt-receiving hollow tube 10-2. One end of the lock bolt rod 10-1-1 is connected to the positioning lock bolt head 10-1-2, and the other end is fixed with a pressure plate 10-1-3. The inner wall of the lock bolt-receiving hollow tube 10-2 has a pressing portion for pressing the spring 10-3. The spring 10-3 is pressed between the pressure plate 10-1-3 and the pressing portion. A steering rod 10-1-4 is arranged on the lock bolt rod 10-1-1 near the positioning lock bolt head 10-1-2. The lock rod-receiving hollow tube 10-2 is provided with a rod slot 1 10-2-1 and a rod slot 2 10-2-2 extending in the tube length direction near the positioning lock bolt head 10-1-2. The depth of rod slot 1 10-2-1 is greater than that of the rod slot 2 10-2-2. When the positioning lock bolt head 10-1-2 abuts against the end of the lock bolt-receiving hollow tube 10-2, the steering rod 10-1-4 is located within the rod slot 1 10-2-1. When the positioning lock bolt head 10-1-2 is inserted into the through hole 2 3-1-5, the steering rod 10-1-4 is located within the rod slot 2 10-2-2.

As illustrated in FIG. 17, the positioning lock retainer 11 is provided with a through cavity 11-1. The positioning lock bolt head 10-1-2 is nested within the through cavity 11-1, which in turn is nested within the through hole 2 3-1-5. A bolt passes through the mounting hole 3 3-1-3 to secure said positioning lock retainer 11 to the profile.

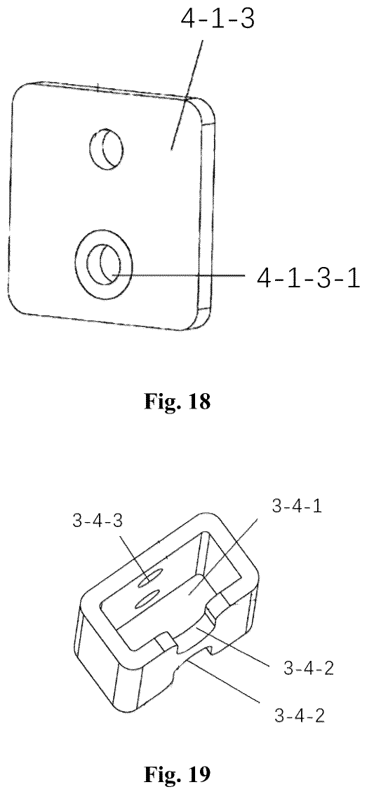

As shown in FIG. 11, the bolt head 4-1-1 is disc-shaped. The bolt rod 4-1-2 comprises a cylindrical connecting bot rod and a fixed bolt rod. One end of the connecting bolt rod is connected to the disc-shaped bolt head, while the other end is connected to the fixed bolt rod. The positioning bolt 4-1 also includes a positioning mounting plate 4-1-3, as illustrated in FIG. 18, which has two insertion holes 1 4-1-3-1. The fixed bolt rod passes through one of insertion holes 1 4-1-3-1 and one of mounting holes 2 3-1-2 in sequence, and is connected to support piece 2 2-3 within frame; the bolt passes through the remaining insertion holes 1 4-1-3-1 and mounting holes 2 3-1-2 in sequence, and is connected to Second support piece 2.

As depicted in FIG. 19, the positioning bolt holder 3-4 includes an insertion hole 2 3-4-1 for the bolt head 4-1-1 to insert into and an insertion hole 3 3-4-2 for the bolt rod 4-1-2. The size of the insertion hole 3 3-4-2 is designed to prevent the bolt head 4-1-1 from passing through. The positioning bolt holder 3-4 is a hollow tubular piece, with the insertion hole 2 3-4-1 from the tube cavity of positioning bolt holder 3-4. The insertion hole 3 3-4-2 is a slotted hole cut into the wall of the hollow tube, extending longitudinally along the tube and reaching one end of the tube. The positioning bolt holder 3-4 also features an insertion hole 4 3-4-3. A bolt passes through the mounting hole 2 3-1-2 on the left profile 3 and then through the insertion hole 4 3-4-3, connecting to the support piece 2.

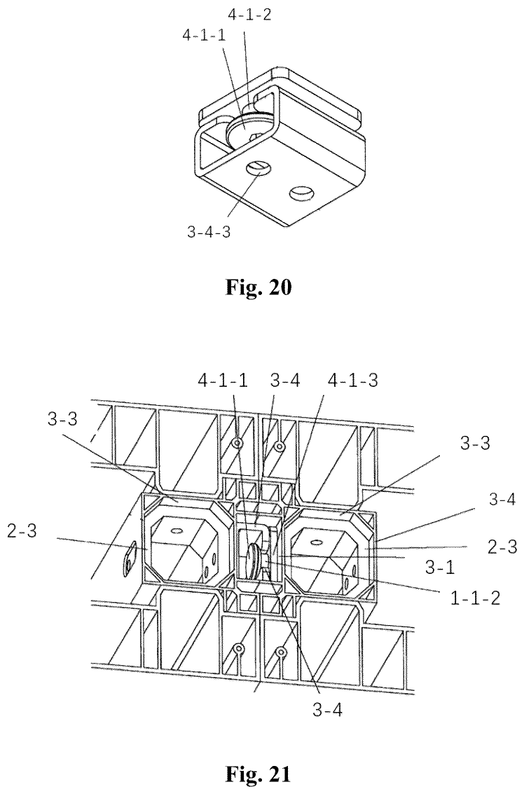

The installation process of the left and right adjacent snap-fit fabric building modules in this invention is as follows: Initially, one snap-fit fabric building module is offset a certain distance from another snap-fit fabric building module in the direction where the positioning bolt 4-1 inserts into the positioning bolt holder 3-4. Subsequently, one side of one snap-fit fabric building module is brought into contact with one side of the other snap-fit fabric building module. Then, the positioning bolt 4-1 is inserted into the positioning bolt holder 3-4, with the bolt head 4-1-1 inserted into insertion hole 1 4-1-3-1 and bolt rod 4-1-2 inserted into the insertion hole 2 3-4-1. The connection between the positioning bolt holder 3-4 and the positioning bolt 4-1 is illustrated in FIG. 20. At this point, the cross-sectional view of both modules when connected is shown in FIG. 21.

Due to the fact that the size of the insertion hole 2 3-4-1 does not permit the bolt head 4-1-1 to pass through and the bolt head 4-1-1 rests precisely against the inner wall surface of the positioning bolt holder 3-4, the bolt rod 4-1-2 can fit exactly into the insertion hole 2 3-4-1. This design ensures that the connecting bolt rod cannot move laterally within the width of the insertion hole 2 3-4-1, thereby achieving precise installation and positioning of the two building module components in the width direction of the insertion hole 2 3-4-1 and along the length of the bolt rod 4-1-2. Subsequently, the steering rod 10-1-4 of the positioning lock 10 is pulled out from the rod slot 1 10-2-1 and rotated around the axis of lock bolt-receiving hollow tube 10-2 by a certain angle, so that the steering rod 10-1-4 is inserted into the rod slot 2 10-2-2. At this point, the positioning lock bolt head 10-1-2 is inserted into the through hole 2 3-1-5. Due to the size of the lock hole, which allows the positioning lock bolt head 10-1-2 to be inserted but not to move within the through hole 2 3-1-5, accurate installation and positioning of the two module components in the insertion direction of positioning bolt 4-1 into the positioning bolt holder 3-4 can be achieved. Ultimately, accurate installation and positioning of the two module components in all directions are realized, while the connection and installation errors are reduced. Moreover, such connection and installation process essentially requires only two steps: inserting the positioning bolt 4-1 into the positioning bolt holder 3-4 and inserting the positioning lock 10 into the through hole 2 3-1-5. The installation process is very simple and efficient. The disassembly process of the two snap-fit fabric building modules is the reverse of the installation process. Initially, the steering rod 10-1-4 is pulled out from the rod slot 2 10-2-2 and rotated around the axis of lock bolt-receiving hollow tube 10-2 by a certain angle. Under the force of the spring 10-3, the steering rod 10-1-4 is inserted into the rod slot 1 10-2-1, allowing the positioning lock bolt head 10-1-2 to disengage from the lock hole. Thereafter, the two snap-fit fabric building modules are offset from each other in the direction in which the positioning bolt 4-1 is inserted into the positioning bolt holder 3-4, causing the positioning bolt 4-1 to be released from the positioning bolt holder 3-4, thus completing the separation of the two snap-fit fabric building modules.

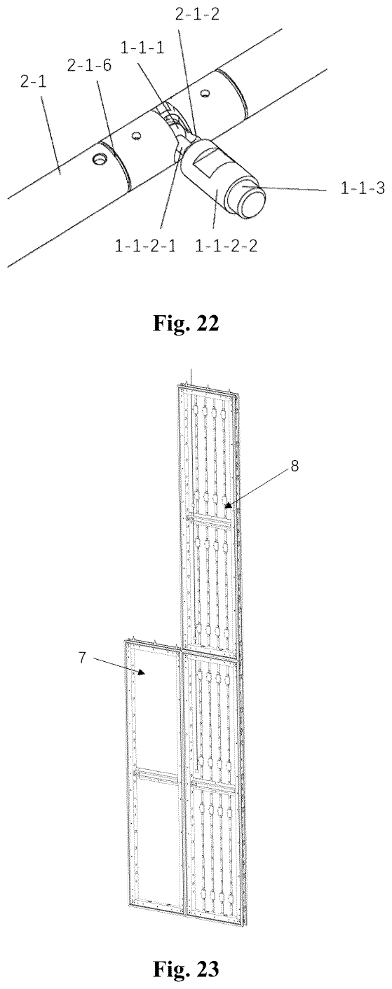

When the upper and lower snap-fit fabric building modules are connected, the lower snap-fit fabric building module, with its positioning pin 1-1 on the upper profile 1, faces the lower profile 2 of the upper module component, which features a circular hollow tube. In this configuration, the spherical head 1-1-1 of the positioning pin 1-1 sequentially inserts into through hole 1 3-1-4 on the profile of the upper module component, the frame corner connector 5, and the insertion hole 1 5-1 on the support piece 1 2-2 within frame, ultimately entering the hole 1 2-1-1 on the circular hollow tube. A portion of the small-diameter rod 1-1-2-1 also enters the hole 1 2-1-1, while the large-diameter rod 1-1-2-2 extends into insertion hole 1 5-1, as shown in the connection between the positioning pin 1-1 and the positioning pin lock piece 2-1 in FIG. 22. At this point, a specialized rotating tool (not shown) is inserted into the through hole 2 3-1-5 of the upper snap-fit fabric building module, which features a claw portion 2-1-3. The specialized rotating tool engages with the claw portion 2-1-3, and when rotated 90 degrees, the circular hollow tube also rotates 90 degrees around its axis. Consequently, the small-diameter rod 1-1-2-1 enters the hole 2 2-1-2, and the spherical head 1-1-1 is trapped within tube cavity of the circular hollow tube, unable to be released. In addition, the head friction limiting member 2-2-4 frictionally contacts and presses tightly against the spherical head 1-1-1, preventing the circular hollow tube from rotating in the opposite direction and causing the head 1-1-1 to disengage from the circular hollow tube. This completes the upper and left connections of the building module, as illustrated in FIG. 23.

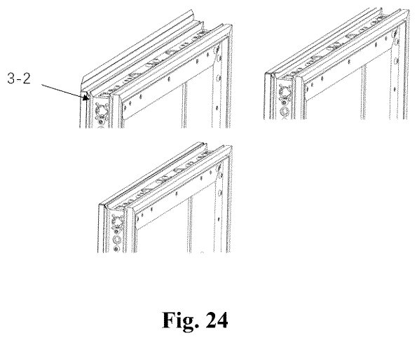

In a preferred embodiment, as shown in FIG. 24, after the installation of the snap-fit building module, a fabric surface can be set on at least one side of the front and back of the frame. This fabric surface covers the light board 8 or the lining board 7 on decorative plane 6 and is clamped within groove 1 3-1 and groove 2 3-2 to enhance the overall aesthetic appeal.

The beneficial effects of this invention:
1) The frame, positioning pins 1-1, positioning pin lock pieces 2-1, positioning bolts 4-1, positioning bolt holders 3-4, and positioning locks 10 of the building module components of this invention are preferably made of metal, while the decoration part is made of plastic. All components are recyclable and reusable, thereby avoiding waste of forest resources and exhibiting excellent environmental friendliness.
2) The connection of the upper and lower building module components requires only the insertion of a positioning pin 1-1 from one module into the positioning pin lock piece 2-1 of another module, causing the lock piece 2-1 to move, preferably rotating. These two steps, connecting the left and right building module components, require only one installation step: inserting the positioning bolt 4-1 of one module into the positioning bolt holder 3-4 of another module. Compared to traditional bolted or welded connections, the connection and disassembly of the module components are much more convenient and efficient, thus remarkably reducing labor, material, and financial costs.
3) All building module components of this invention are standardized to significantly reduce the customization cycle and economic costs.
4) The upper and lower, as well as left and right building module components, can all be accurately positioned during installation to remarkably reduce errors during the installation & connection.
5) When two building module components are assembled together, the positioning pins 1-1, positioning bolts 4-1, positioning bolt holders 3-4, and positioning locks 10 are all concealed within the frame members of the building module, resulting in a visually appealing overall design.
6) The light board 8 and lining board 7 are installed within the decorative plane 6 formed by the frame module to effectively reduce damage from impacts. Where the snap-fit fabric building module of this invention is reused, only the snap-fit fabric installed in groove 2 3-2 needs to be replaced, thus ensuring ease of use.

What is claimed is:

1. A snap-fit fabric building module is disclosed, characterized by comprising a frame, a lining board, and a light board;
The frame includes an upper profile, a lower profile, a left profile, a right profile, and four corner connectors, with two decorative planes formed on either side of the frame;
Said upper profile, lower profile, left profile, right profile, and the four corner connectors are connected through mounting holes 1;
Said lining board and the light board can be selectively installed within the frame;
Said lining board and light board can be installed inside the frame without protruding beyond the decorative plane;
Said lining board and light board are connected to the frame through mounting hole 1 and mounting hole 2.

2. The snap-fit building module according to claim 1, characterized in that said upper profile, said lower profile, said left profile, and said right profile are four profiles with identical cross-sections;
At least one of said upper profile, said lower profile, said left profile, and said right profile is provided with at least one of the following: positioning pin, positioning pin lock piece, positioning bolt, and positioning bolt holder;
Said positioning pin includes a head portion, a rod portion, and a mounting rod;
Said positioning pin lock piece is provided with interconnected holes 1 and 2. The size of hole 1 allows the head to pass through, while the size of hole 2 does not allow the head to pass through but allows the rod to pass through.
Said positioning bolt includes a bot head and a bolt rod, with said bolt head connected to said bolt rod. Said positioning bolt holder is provided with a slot or hole for the insertion of said positioning bolt.

3. The snap-fit building module according to claim 2, characterized in that said positioning pin is disposed on said upper profile; said positioning pin lock piece is disposed on said lower profile; said positioning bolt is disposed on said right profile; and said positioning bolt holder is disposed on said left profile.

4. The snap-fit building module according to claim 3, characterized in that said upper profile, said lower profile, said left profile, and said right profile have cavities, groove 1, and groove 2 that extend in the longitudinal length direction of the profile;
Said groove 1 and said groove 2 are disposed on one side of said upper profile, said lower profile, said left profile, and said right profile;
Said groove 1 is provided with a through hole 1 for said positioning pin to pass through, a through hole 2 for said positioning pin lock piece to insert into, and a through hole 3 for installing said positioning bolt and said positioning bolt holder;
Said through hole is surrounded by a mounting hole 3;
Both said positioning bolt and positioning bolt holder is disposed on the bottom of said groove 1;
Said four corner connectors are inserted into said cavities of adjacent two profiles;
Said cavities of said upper profile and said lower profile are inserted with support piece 1 within frame and support piece 2 within frame, while said cavities of said left profile and said right profile are inserted with support piece 1 within frame and support piece 3 within frame;
Said corner connectors and said support piece 1 within frame are both provided with an insertion hole 1 for said positioning pin to pass through and insertion hole 2 for the positioning pin lock piece to pass through;
Said support piece 2 within frame is used to install said positioning bolt and said positioning bolt holder on said left profile and said right profile;
Said support piece 3 within frame is provided with insertion hole 3;
The orientation of said support piece 3 within frame is the same or opposite to that of support piece 1 within frame.

5. The snap-fit building module according to claim 4, characterized in that said frame is also provided with a transverse support module;
Said transverse support module includes a transverse support piece and a transverse support frame;
Said transverse support frame is provided with at least one reinforcing rib;
When there are two said reinforcing ribs, said transverse support piece is inserted at both ends of said transverse support piece and connected by bolts;
Said transverse support frame is provided with a mounting hole 2, and said lining board and said light board can be optionally connected to said transverse support frame through said installation hole 2;
Said transverse support frame is aligned with said left profile and said right profile and connected to said support piece 3 within frame through insertion hole 3.

6. The snap-fit building module according to claim 2, characterized in that said head is a spherical head, and said rod is a cylindrical rod;
Said rod includes a small-diameter rod connected to a large-diameter rod;
One end of said small-diameter rod is connected to said head portion, and the other end is connected to the large-diameter rod;
The diameter of said small-diameter rod is less than the diameter of said spherical head. One end of said large-diameter rod is connected to said small-diameter rod, and the other end is connected to said upper profile;
Said mounting rod is connected to said through hole 1;
Said positioning pin lock piece is a hollow tube with a circular cross-section. Said hole 1 is a circular hole, and said hole 2 is a slotted hole extending along the circumference of the cross-section of the hollow tube.

7. The snap-fit building module according to claim 6, characterized in that at least one end of the positioning pin lock piece has a claw portion for driving the positioning pin lock piece to rotate;
Said positioning pin lock piece is provided with a head friction limiting member fixedly disposed therein. When the head portion is inserted into hole 1 and the hollow tube is rotated around its axis, the rod enter hole 2, and said head friction limiting member is in frictional contact with the head;
The width of said hole 2 allows the small-diameter rod to enter hole 2 but does not allow the small-diameter rod to move in the width direction of hole 2.

8. The snap-fit building module according to claim 1, characterized in that said frame further includes a positioning lock and a positioning lock retainer;
Said positioning lock is disposed on one of a pair of opposite profiles;
Said positioning lock includes a retractable and extendable lock bolt, a lock bolt-holding hollow tube, and a spring;
Said lock bolt comprises a bolt rod and a positioning lock bolt head;
Said bolt rod is mounted on said spring and installed within the cavity of said lock bolt-holding hollow tube;
One end of said lock bolt rod is connected to said positioning lock bolt head, and the other end is fixed with a pressure plate;
The inner wall of said lock bolt-holding hollow tube has a pressing portion for pressing said spring;
Said spring is compressed between said pressure plate and said pressing portion;
Said lock bolt rod is provided with a steering rod near said positioning lock bolt head;
Said lock bolt-holding hollow tube is provided with rod slot 1 and rod slot 2 extending in longitudinal direction of said lock bolt-holding hollow tube near the end with said positioning lock bolt head;
The depth of said rod slot 1 is greater than the depth of said rod slot 2;
When said positioning lock bolt head abuts against the end of said lock bolt-receiving hollow tube, said steering rod is located within said rod slot 1; when said positioning lock bolt head is inserted into said through hole 2, said steering rod is located within said rod slot 2;
Said positioning lock retainer is provided with a through cavity;
Said positioning lock bolt head is nested within said through cavity;
Said through cavity is nested within said through hole 2;
A bolt passes through mounting hole 3 to fix the positioning lock retainer to the profile.

9. The snap-fit building module according to claim 2, characterized in that said bolt head is a disc-shaped head; said bolt rod includes a cylindrical connecting bolt rod and a fixed bolt rod;
One end of said connecting bolt rod is connected to said disc-shaped bolt head, and the other end of said connecting bolt rod is connected to said fixed bolt rod;
Said positioning bolt also includes a positioning mounting plate; said positioning mounting plate is provided with a plurality of insertion holes 1;
Said fixed bolt rod passes through one of insertion holes 1 and one of said mounting holes 2 in sequence, and is connected to said support piece 2 within frame; the bolt passes through the remaining said insertion holes 1 and said mounting holes 2 in sequence, and is connected to Second support piece 2;
Said positioning bolt holder includes insertion hole 2 for said bolt head to insert into and insertion hole 3 for said bolt rod to insert into;
The size of said insertion hole 3 does not allow said bolt head to pass through;
Said positioning bolt holder is a hollow tube, and said insertion hole 2 is the cavity of said hollow tube;
Said insertion hole 3 is a slot-shaped hole in the wall of said hollow tube that extends longitudinally along said hollow tube;
One end of said insertion hole 3 extends to the end of the hollow tube;
An insertion hole 4 is provided on said positioning bolt holder;
A bolt passes through mounting hole 2 on said left profile and said insertion hole 4 in sequence, and is connected to said support piece 2.

10. The snap-fit building module according to claim 1, characterized in that at least one side of the front and back sides of the frame is provided with a fabric surface; said fabric surface covers said decorative plane and snap-fitted in said groove 1.
